(19) United States
(12) Patent Application Publication
(10) Pub. No.: US 2007/0080869 A1
(43) Pub. Date: Apr. 12, 2007

(54) Antenna structure on circuit board

(75) Inventors: Shu-Chih Chen, Tainan City (TW); Chun Yi Chang, Tainan City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/544,255

(22) Filed: Oct. 6, 2006

(30) Foreign Application Priority Data
Oct. 12, 2005 (TW) 94135482

(51) Int. Cl. H01Q 1/38

(52) U.S. Cl. 343/700 MS

(57) ABSTRACT

An antenna structure formed on a circuit board includes a first main body formed on the lateral side of the circuit board and a feed line connecting the circuit board and the first main body. The first main body is formed on the lateral side of the circuit board by edge-plating.

### BACKGROUND

The invention relates to an antenna structure, and in particular to an antenna structure formed on one lateral side of a circuit board.

Mobile phones have two types of antenna, an external antenna or a printed antenna. As mobile phones become increasingly compact, printed antennas are preferable.

Circuit boards for electronic devices have multiple layers. A blank region is formed near one edge of the circuit board for a printed antenna layout. A conventional printed antenna is coplanar with the circuit. Referring to FIG. 1, a blank region 12 is formed near one edge of a circuit board 10. Printed circuits are disposed outside the blank region 12. A printed antenna 20 is formed in the blank region 12 adjacent to the edge of the circuit board 10. The antenna has an L-shaped grounding path 22 for resistance matching. FIG. 2 depicts a cross section of a region A of FIG. 1. In FIG. 2, the circuit board 10 has eight layers (L1˜L8). The blank region 12 is disposed on the first layer L1. The antenna 20 is printed in the blank region 12 near the edge of the circuit board 10.

As a mobile phone becomes more compact, the circuit board becomes smaller, and the size of the blank region is also reduced. When the blank region is reduced, the antenna may be inefficient.

### SUMMARY

An embodiment of an antenna structure of the invention comprises a first main body formed on the lateral side of the circuit board and a feed line connecting the circuit board and the first main body.

The antenna structure further comprises a second main body adjacent to the first main body formed on the front of the circuit board.

The first main body is formed on the lateral side of the circuit board by edge-plating.

### BRIEF DESCRIPTION OF THE DRAWINGS

The invention can be more fully understood by reading the subsequent detailed description and examples with references made to the accompanying drawings, wherein:

FIG. 1 is a schematic view of a conventional antenna structure formed on a circuit board;

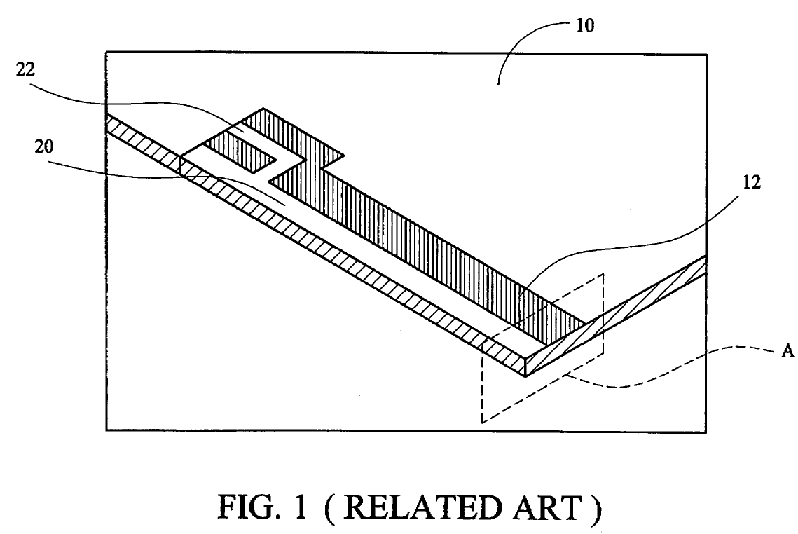

FIG. 2 is a cross section of a region A of FIG. 1;

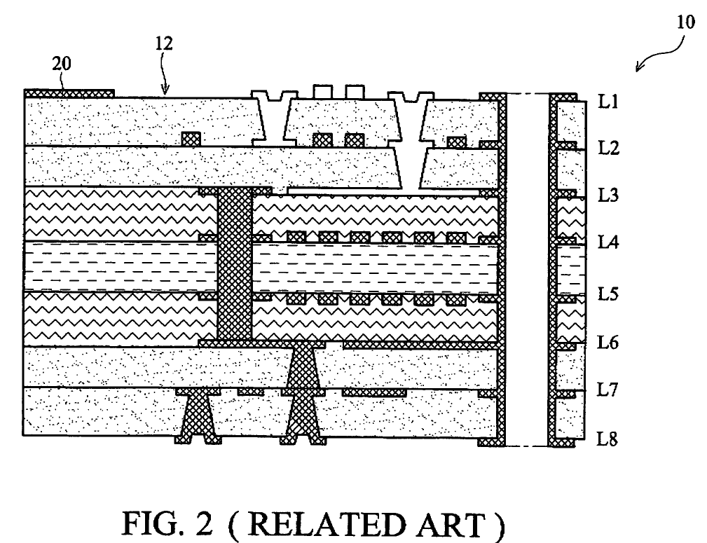

FIG. 3 is a schematic view of an embodiment of an antenna structure of the invention;

FIG. 4 is a cross section of a region B of FIG. 3;

FIG. 5 is a diagram of return loss and efficiency of an embodiment of the invention and the conventional antenna; and

FIG. 6 is a diagram of return loss and efficiency of another embodiment of the invention and the conventional antenna.

### DETAILED DESCRIPTION

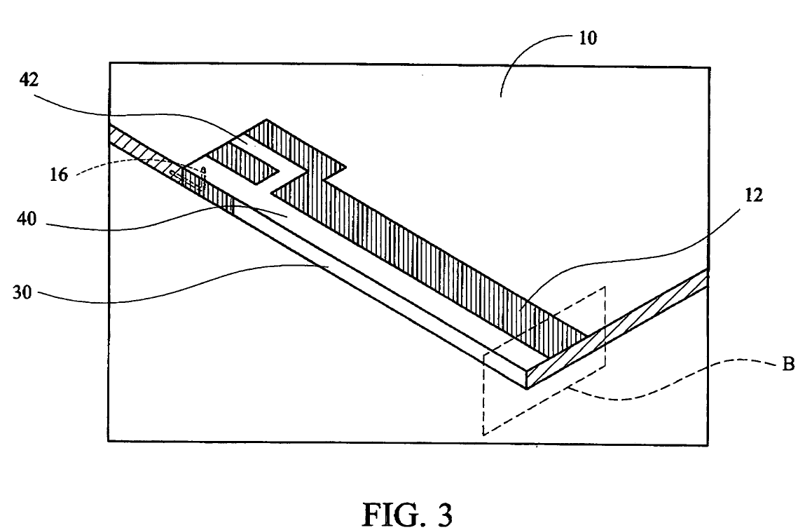

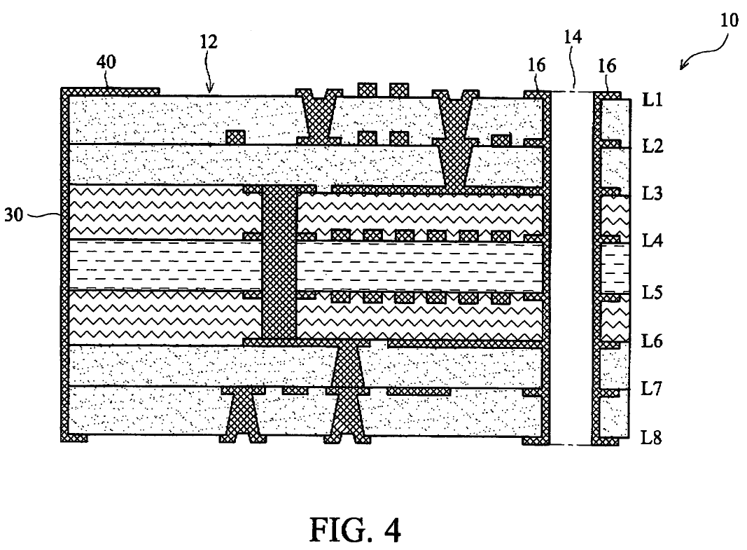

Referring to FIGS. 3 and 4, a circuit board 10 has a blank region 12 adjacent to one edge of the circuit board 10. An antenna structure comprises a first main body 30 and a second main body 40. The first main body 30 is formed on one lateral side of the circuit board 10, and the second main body 40 is formed in the blank region 12 and adjacent to the first main body 30. The antenna structure further comprises a feed line 16 and a grounding path 42. The feed line 16 is disposed in the circuit board 10. The grounding path 42 is L-shaped and connected to the second main body 40 for resistance matching. The antenna structure is disposed in the blank region 12 and the lateral side of the circuit board 10.

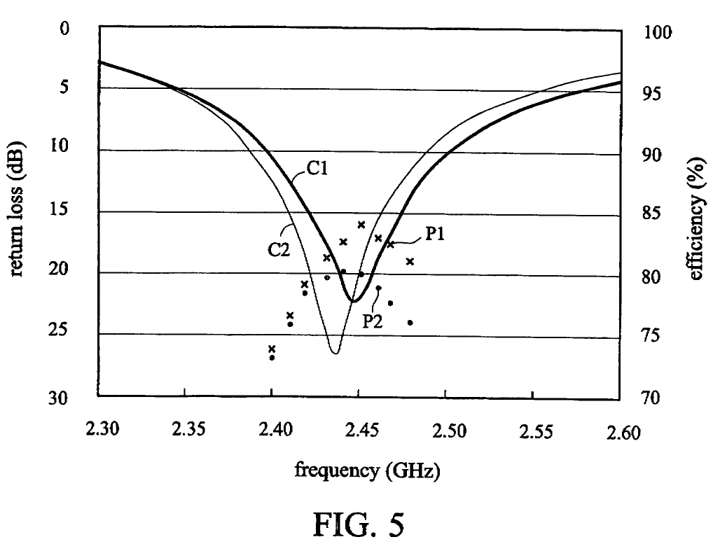

FIG. 5 is a diagram depicting return loss and efficiency of an embodiment of the antenna of the invention and the conventional antenna respectively. In FIG. 5, the traverse axis represents frequency, the left longitudinal axis represents return loss, and the right longitudinal axis represents efficiency. In this embodiment, the blank region 12 is 3 mm×20.5 mm, the thickness of the circuit board 10 is 1 mm. For the blue tooth frequency of 2.45 GHz, C1 represents the return loss of the embodiment and C2 represents the return loss of a conventional antenna. P1 represents the efficiency of the embodiment, and P2 represents the efficiency of the conventional antenna. As shown in FIG. 5, the efficiency of the embodiment is greater than that of the conventional antenna.

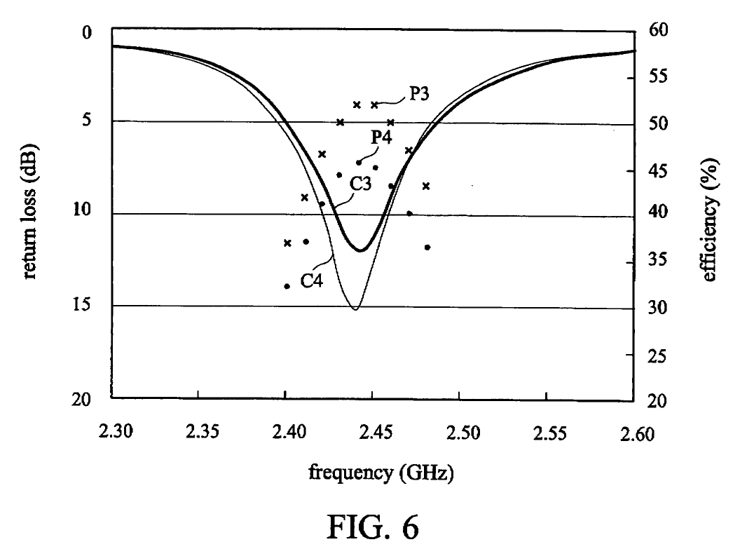

FIG. 6 is a diagram depicting return loss and efficiency of another embodiment of the invention and the conventional antenna. In this embodiment, the blank region 12 is 1.5 mm×16.8 mm, and the thickness of the circuit board 10 is also 1 mm. C3 and C4 represent the return loss of the embodiment of the antenna and the conventional antenna respectively. P3 and P4 represent the efficiency of the embodiment and the conventional antenna respectively.

Referring to FIGS. 5 and 6, when frequency is 2.45 GHz, the embodiment of the antenna has better efficiency. In FIG. 6, as the blank region is reduced, the efficiencies of the embodiment and the conventional antenna are both reduced, the invention, however, has better efficiency than the conventional antenna.

The following paragraph describes how the first main body 30 is formed on one lateral side of the circuit board 10. In general, the circuit board 10 is first completely plated with copper, and then etched to remove the copper layer on the lateral side, and the circuit is formed by a patterned mask. In the invention, however, when the circuit board is etched, the copper on the lateral side of the circuit board remains to form the first main body 30. The second main body 40 is formed by the patterned mask.

The length of first main body 30 and the second main body 40 is corresponding to the material of the circuit board and the frequency.

The length of an inverted F antenna has the following correlation:

$$L \approx \frac{{λ}_{e}}{4} = \frac{C}{4 \sqrt{{ɛ}_{e}} \cdot f} ∝ \frac{C}{4 \sqrt{{ɛ}_{r}} \cdot f}$$

L is 1/4 the effective wave length λₑ, C is light speed, εₑ is the effective dielectric coefficient, εᵣ is the dielectric coefficient of circuit board, f is frequency.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure formed on a circuit board, comprising:
a first main body formed on a lateral side of the circuit board; and
a feed line connected to the circuit board and the first main body.

2. The antenna structure as claimed in claim 1 further comprising a second main body adjacent to the first main body and formed on a front of the circuit board.

3. The antenna structure as claimed in claim 1, wherein the first main body is formed on the lateral side of the circuit board by edge-plating.

4. The antenna structure as claimed in claim 1, wherein the length of the first main body is longer than 14 mm and smaller than 40 mm when the material of the circuit board is glass fiber.

5. The antenna structure as claimed in claim 1, wherein the length of the first main body is longer than 18 mm and smaller than 50 mm when the material of the circuit board is polycarbonate.

6. The antenna structure as claimed in claim 1, wherein the length of the first main body is larger than 20 mm and smaller than 59 mm when the material of the circuit board is Teflon.

7. The antenna structure as claimed in claim 1, wherein the length of the first main body is longer than 8 mm and smaller than 25 mm when the material of the circuit board is silicon.

8. A method of forming an antenna structure, comprising the following steps:
providing a circuit board having a lateral side and a front;
plating the front and the lateral side; and
etching the circuit board to form a first main body on the lateral side and a second main body on the front, wherein the second main body is adjacent to the first main body.
